(19) United States
(12) Patent Application Publication
(10) Pub. No.: US 2015/0058393 A1
(43) Pub. Date: Feb. 26, 2015

(54) CROSS DEVICE VISITOR CORRELATION

(71) Applicant: Adobe Systems Incorporated, San Jose, CA (US)

(72) Inventors: Kevin Gary Smith, Lehi, UT (US); William Brandon George, Pleasant Grove, UT (US)

(73) Assignee: Adobe Systems Incorporated, San Jose, CA (US)

(21) Appl. No.: 13/971,648

(22) Filed: Aug. 20, 2013

(51) Int. Cl. H04L 29/08

(52) U.S. Cl. CPC H04L 67/10
USPC 709/201

(57) ABSTRACT

In embodiments of cross device visitor correlation, application data is generated by an application executing on a computing device, and a visitor identifier is included in the application data. The visitor identifier is associated with the computing device for a user who is not identified at the computing device from a user-provided log-in credential or email address. The application data can be communicated to a cloud data storage that maintains the application data to update instances of the application on one or more additional computing devices when the application data is requested. An additional computing device can receive the application data along with the visitor identifier, and then return the visitor identifier back to the cloud storage along with updated application data. A user of the computing device and the additional computing device is correlated as the same visitor by a visitor profile server based on the visitor identifier.

### BACKGROUND

Many people today have multiple and different types of devices that they use to access the Internet for a multitude of reasons, such as to shop for consumer goods, find a service provider, for entertainment, for social networking, and/or for many other business and personal reasons. For example, one person may connect and access the Internet at various times of the day from any number of different devices, such as a mobile phone, a tablet device, a desktop computer, a network-enabled television, from his or her car, and with other electronic media devices.

Providers of applications and on-line access to goods and services seek to track visitors who download applications and visit Web sites to better understand how users interact with their technology. The access and application providers particularly want to know such information as why a user visits a particular Web site, what the visitor does and how the visitor navigates through the site, where the visitor ends up, and why the visitor leaves and/or goes to a different site. A user that has multiple devices makes this type of tracking difficult because the user will appear as a different visitor on each device. For example, a user who clicks on an advertisement starting a Web site visit from one device, and then later makes a purchase from a second device, will appear first as an actively acquired visitor who failed to convert and second as a separate visitor of unknown acquisition who did convert when making the purchase. A visitor who appears and makes a purchase without seemingly having first viewed and selected an advertisement may simply be changing devices. An acquisition campaign associated with the purchased product or service will not be properly credited because the visitor first appeared as an actively acquired visitor who failed to convert.

In many cases, browser application cookies are used to identify a returning visitor to a Web site and/or pages of the site. However, cookies are not utilized across different devices, or even across browser applications on the same device, and cookies do not identify a user of multiple, different devices. Typically, a person that appears as two different visitors to a particular Web site is only recognized as the same individual if the person logs-in to the site from both of the devices used to access the Web site. Many times however, users do not log-in, or prefer not to provide the information needed to setup a login account.

### SUMMARY

This Summary introduces features and concepts of cross device visitor correlation, which is further described below in the Detailed Description and/or shown in the Figures. This Summary should not be considered to describe essential features of the claimed subject matter, nor used to determine or limit the scope of the claimed subject matter.

Cross device visitor correlation is described. In embodiments, application data is generated by an application executing on a computing device, and a visitor identifier is included in the application data by a data transfer module of the application. The visitor identifier is associated with the computing device for a user who is not identified at the computing device from a user-provided log-in credential or from an email address. The application data can be communicated to a cloud data storage that maintains the application data to update instances of the application on one or more additional computing devices that request the application data from the cloud data storage. An additional computing device can request and receive the application data along with the visitor identifier, and then return the visitor identifier back to the cloud data storage along with updated application data. A user of the computing device and the additional computing device is correlated as the same visitor by a visitor profile server based on the visitor identifier that is received from both of the computing devices. Additionally, the user can be correlated with multiple computing devices based on the visitor identifier that is associated with the user who is not otherwise identified from a log-in credential or an email address at the multiple computing devices.

In other embodiments, application data is received at a cloud data storage from an application executing on a computing device, and the application data includes a visitor identifier that is associated with the computing device for a user who is not identified from a user-provided log-in credential or from an email address. A request can be received from an additional computing device for the application data to update an instance of the application on the additional computing device. The request includes the visitor identifier that is also associated with the additional computing device for the user who is also not identified at the additional computing device. In implementations, the visitor identifier can identify a unique aspect of the user who is otherwise an unidentified user of the computing device and the additional computing device. The visitor identifier that is included with the application data received from the computing device can be correlated with the visitor identifier included in the request from the additional computing device. Further, the computing device can be correlated with the additional computing device based on the visitor identifier, and the requested application data is communicated to the additional computing device to update the instance of the application that is executing on the additional computing device.

In implementations, the visitor identifier can be a tracking code or tracking pixel included in a message that is received at the computing device for viewing by the user, and the message has relevance to the application executing on the computing device. For example, the user of the computing device may receive an email message that includes an incentive to use the application, such as a gaming application. The cloud data storage can then receive the application data that includes the tracking code or tracking pixel from the computing device. The user may also open the email message while using an additional, different computing device, and a request for the application data that is received from the additional computing device includes the tracking code or tracking pixel. In this instance, the user is identifiable based on a message address of the message, such as an email address corresponding to the user, and the computing device and the additional computing device are correlated with the identified user based on the tracking code or tracking pixel.

In alternate implementations, a visitor identifier received from one computing device may be different than the visitor identifier received from an additional computing device. For example, a visitor profile server can communicate a message to a user for viewing at a computing device, where the message includes an incentive related to an application that is executable on the computing device, and the message includes a tracking identifier associated with the user. The visitor profile server receives a first visitor identifier from the computing device along with the tracking identifier when the incentive is initiated by the user at the computing device. The user may also access the message while using an additional, different computing device and the visitor profile server receives a second visitor identifier from the additional computing device along with the tracking identifier when the incentive is initiated by the user at the additional computing device. The first visitor identifier and the second visitor identifier can be correlated with the user based on the tracking identifier received back from the computing device and the additional computing device. Additionally, the user can be correlated with the computing device and the additional computing device based on the tracking identifier being received back from both of the devices.

### BRIEF DESCRIPTION OF THE DRAWINGS

Embodiments of cross device visitor correlation are described with reference to the following Figures. The same numbers may be used throughout to reference like features and components that are shown in the Figures:

FIG. 1 illustrates an example system in which embodiments of cross device visitor correlation can be implemented.

FIG. 2 illustrates an example method of cross device visitor correlation in accordance with one or more embodiments as described with reference to the example system shown in FIG. 1.

FIG. 3 illustrates another example method of cross device visitor correlation in accordance with one or more embodiments as described with reference to the example system shown in FIG. 1.

FIG. 4 illustrates another example system in which embodiments of cross device visitor correlation can be implemented.

FIG. 5 illustrates an example method of cross device visitor correlation in accordance with one or more embodiments as described with reference to the example system shown in FIG. 4.

FIG. 6 illustrates an example system with an example device that can implement embodiments of cross device visitor correlation.

### DETAILED DESCRIPTION

Embodiments of cross device visitor correlation are described to track unidentified users across multiple, different devices. A person may use any number of devices, such as a mobile phone, a tablet device, a desktop computer, and other electronic media devices and/or systems. Visitor identifiers from the multiple computing devices can be associated to correlate the user with the multiple, different computing devices, particularly in instances where a user is not identified by a log-in credential, or associated with an email address or other specific user identifier of the user. Identifying a user across multiple devices is also referred to as stitching a user together based on visitor identifiers that identify some aspect of the user and/or the computing devices that are determined as being associated with the user.

Embodiments of cross device visitor correlation can be utilized when transferring data from one computing device to another, and/or with synching the data between multiple computing devices. The described implementations can be used for data import and export, such as for any type of application configuration and user preferences, as well as to update gaming applications across devices for game status, points accumulated, levels attained, player updates, and any other data related to a user playing a gaming application. Implementations of cross device visitor correlation may similarly be used for features of augmented functionality, such as to provide additional functionality if a person uses multiple devices at the same time. For example, a different view of data may be displayed on each of the different devices, such as on a desktop computing device or network-enabled television device, and then also on a tablet device that is being used as a companion device to the computing or television device. In the instance of a gaming application, a secret level may be enabled if the user plays the game on both the desktop computing device or network-enabled television device, and then also on a tablet device or mobile phone.

While features and concepts of cross device visitor correlation can be implemented in any number of different devices, systems, networks, environments, and/or configurations, embodiments of cross device visitor correlation are described in the context of the following example devices, systems, and methods.

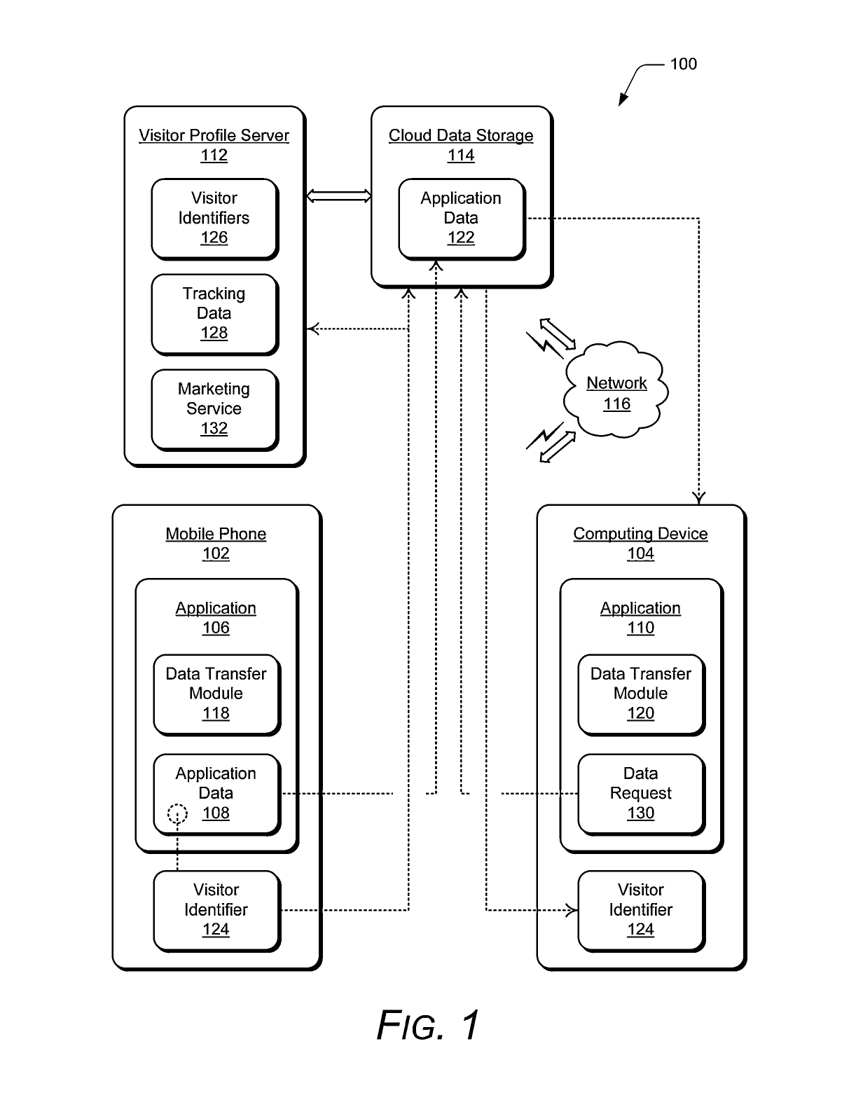

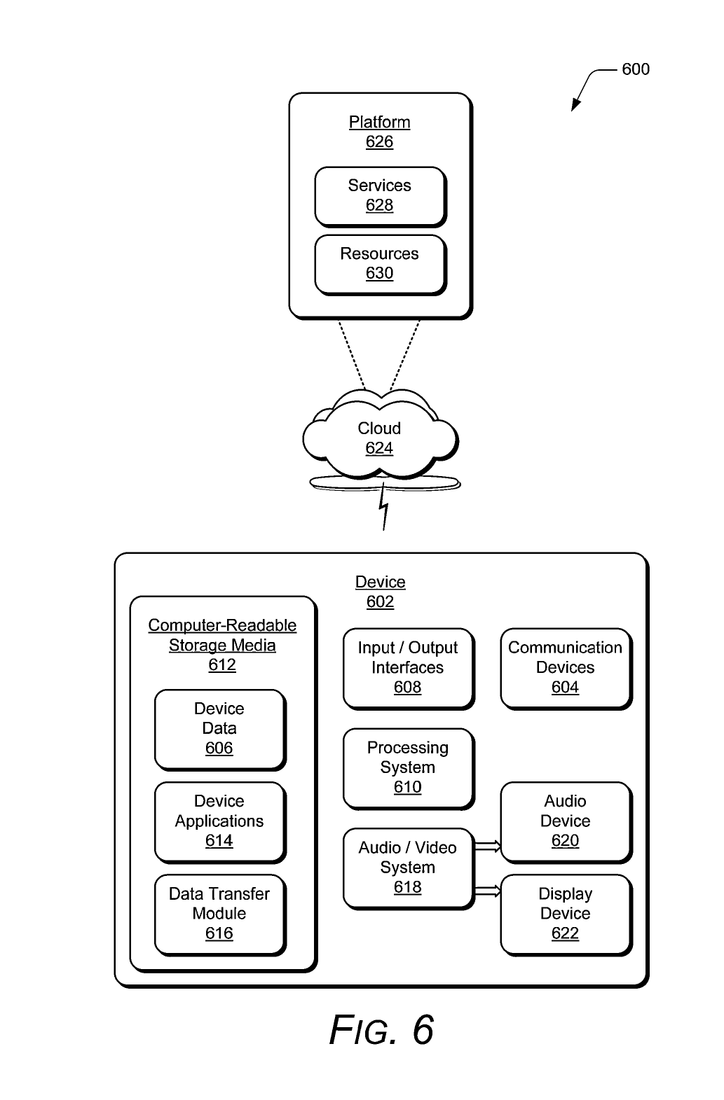

FIG. 1 illustrates an example system 100 in which embodiments of cross device visitor correlation can be implemented. The example system 100 includes computing devices that a person may use at different times throughout his or her day, including a mobile phone 102 and any other type of a computing device 104, such as a tablet device, a desktop computer, a network-enabled television, a media playback device, a network-connected car, and other computing, communication, gaming, entertainment, and/or electronic media devices. Any of the devices can be implemented with various components, such as a processing system and memory, and with any number and combination of differing components as further described with reference to the example device shown in FIG. 6. Although only two computing devices are shown in this example (i.e., the mobile phone 102 and the computing device 104), a person may have and use several different devices, and the computing device 104 is representative of one or multiple different devices. Further, the mobile phone 102 is also a computing device in the context of this description, and identified as a mobile phone simply for convenience of discussion.

In this example system 100, the mobile phone 102 includes an application 106, such as any type of application that is executable on the mobile phone and generates application data 108. For example, the application 106 may be a gaming application that the user plays on the device, and the application data includes any type of game status, such as points accumulated, levels attained, player updates, and any other data related to playing the gaming application. Alternatively, the application may be any other type of device application and/or software, such as a blog reader or a social media application on the computing device. Typically, a user doesn't need to log-in (i.e., provide a log-in credential) to view selected blogs or social media posts on the various computing devices that the person may use throughout the day to follow and read the selected blogs and social media posts.

The computing device 104 also includes an application 110, which is an instance (or instantiation) of the application 106 on the mobile phone 102. For example, users that have multiple devices may want to access the same social media site and/or play the same game on more than one of their devices, such as on the mobile phone 102, on a tablet device, and/or on another type of computing device 104. Additionally, if the user is reading a large number of social media posts on the mobile phone 102, and later changes devices to use the computing device 104, the user will likely not want to have to scroll through all of the previously viewed content to continue where he or she left-off reading on the other device. In this example, the application data 108 can include the scroll position in the social media posts where the user left-off reading on the mobile phone 102 and where to pick back up when reading the social media posts on the computing device 104. Similarly, the application data 108 can include gaming application status and updates, such as when the game has been played on another device.

The example system 100 also includes a visitor profile server 112, as well as a cloud data storage 114 that may be implemented as any suitable memory, memory device, or electronic data storage for network-based data storage. The visitor profile server 112 and/or the cloud data storage 114 may include server devices and applications, and can be implemented with various components, such as a processing system and memory, as well as with any number and combination of differing components as further described with reference to the example device shown in FIG. 6. The cloud data storage 114 may be associated with the application 106 (and the second instance of the application 110) that is installed and executable on the computing devices. Alternatively or in addition, the cloud data storage may be associated with the computing devices themselves and/or associated with the user of the computing devices.

Although the user of the devices may not be logged-in to an application on a computing device, the mobile phone 102 and the computing device 104 may be previously associated with the cloud data storage 114, such as when initially set up by a user. Further, the cloud data storage may be associated with a developer of the application 106 (and the second instance of the application 110) that is installed and executable on the computing devices, associated with a cloud-based service and data storage provider, and/or with any other type of entity, such as the visitor profile server 112 that, in the context of cross device visitor correlation, seeks to correlate the computing devices with each other and/or with the user of the computing devices.

Any of the devices, servers, and/or services described herein can communicate via a network 116, such as for data communication between the mobile phone 102, the computing device 104, the visitor profile server 112, and the cloud data storage 114, and the network can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

The application 106 on the mobile phone 102 includes a data transfer module 118 (or similar software component). The application 106 and the data transfer module 118 can be maintained on the mobile phone 102 as executable instructions that are stored on computer-readable storage media, such as any suitable memory device or electronic data storage. Additionally, the data transfer module can be executed with a processing system of the mobile phone to implement embodiments of cross device visitor correlation.

The data transfer module 118 is implemented to initiate communicating the application data 108 from the mobile phone 102 to the cloud data storage 114 where the application data can then be requested by the instance of the application 110 on the computing device 104 to update the application. Similarly, the application 110 on the computing device 104 includes a data transfer module 120 (or similar software component) to facilitate application data transfer to other devices, such as back to the mobile phone 102. In the gaming application example, the user may play the game on the mobile phone 102 and the application data 108 is updated for game status, points accumulated, levels attained, player updates, and other data related to playing the gaming application.

The mobile phone 102 can then communicate the application data 108 that is generated by the application 106 to the cloud data storage 114. The cloud data storage 114 receives the application data 108 from the mobile phone 102 and stores the data as application data 122. The application data 108 can also include a visitor identifier 124 that is associated with the mobile phone for a user who is not otherwise identified at the mobile phone from a user-provided log-in credential, an email address, or other type of specific user identifier. For example, the user of the mobile phone 102 can play the game on the mobile phone without logging-in to the phone or the game, and the application data 108 is communicated to the cloud data storage without the user being specifically identified.

In implementations, the visitor identifier 124 can be included with the application data 108 by an operating system of the mobile phone, or the data transfer module 118 can access the operating system to obtain the visitor identifier for inclusion with the application data. Additionally, the visitor identifier 124 is communicated to the visitor profile server 112, either directly as a tracking call to the visitor profile server and/or via the cloud data storage 114 if the visitor profile server and cloud data storage are implemented for data communication with each other.

A visitor identifier may be a common unique identifier that uniquely identifies a user of multiple computing devices, such as the mobile phone 102 and the computing device 104. A common unique identifier can be acquired as a user input or by detection to determine and correlate a user with the multiple computing devices. A common unique identifier can include a serial number of licensed software that is installed on multiple computing devices used by the user, a software license code, an email address, a phone number, or any other type of unique identifier. For example, a user may install the application 106 on the mobile phone 102 and install the same application 110 having a common serial number or software license code on the computing device 110. A unique identifier of a user that is detected on more than one computing device may be related to data and/or how the user uses the computing device, such as message headers created by the user or where the user links to in browser applications. For example, the user may link to the same x-number of blog sites from more than one computing device and the combination of the x-number of blog sites can be hashed down to a unique identifier of the user. Any other type of discernable, unique combination of information and/or data can be used to generate a unique identifier of the user.

The visitor profile server 112 receives the visitor identifier 124 (stored as one of visitor identifiers 126) from the mobile phone 102, along with any other type of tracking data 128, such as any type or combination of information and/or data that can be used to determine a unique identity of a user of the computing devices. The visitor profile server 112 can store and map the visitor identifiers 126 and the tracking data 128 from multiple computing devices, and for any number of different device applications and/or user profiles. In the gaming example, the user may want to continue playing the same game on the computing device 104 at a later time, and starts the application 110 (e.g., an instance of the same application 106 that is on the mobile phone 102). The data transfer module 120 of the application 110 on the computing device can initiate a data request 130 for the application data 122 from the cloud data storage to update the application 110. In the gaming application example, the game status, points accumulated, levels attained, player updates, and other data related to playing the game can be updated on the computing device 104 so that the user can continue playing the game from where he or she left off when previously playing on the mobile phone.

The cloud data storage 114 communicates the application data 122 to the computing device 104 to update the instance of the application 110. The application data that is communicated to the computing device 104 also includes the visitor identifier 124 that originated from the mobile phone 102. When the visitor identifier 124 is communicated from one computing device to another, such as via any of the methods described herein, the receiving device (e.g., the computing device 104) stores the received visitor identifier as the visitor identifier that is to be used when sending analytics and/or the tracking data 128 back to the visitor profile server 112. When the computing device 104 initiates a tracking call to the visitor profile server 112, such as to track an event or an update in an application, the computing device 104 includes the visitor identifier 124 with the tracking call. The visitor profile server 112 can then detect the same visitor identifier 124 on multiple tracking calls, even from the different computing devices that are simply synching data on the same visitor identifier, and “stitch” them together.

The visitor profile server 112 can correlate the mobile phone 102 from which the application data 108 is generated with the computing device 104 that requests the application data based on the visitor identifier 124 from the mobile phone. Each of the data transfer modules 118 and 120 of the respective instances of the application can also be implemented to correlate the mobile phone with the computing device based on the visitor identifier. In implementations, the visitor identifier 124 may be a user identifier that is associated with the cloud data storage 114 allocated to the user of the mobile phone and the computing device. In this instance, the data transfer modules 118 and 120 of the respective instances of the application can also correlate the mobile phone and the computing device with the user based on the user identifier of the user who is allocated the cloud data storage.

In this example, the cloud data storage 114 facilitates the transfer of the application data 122 from the mobile phone 102 to the computing device 104, and the visitor profile server 112 and/or the data transfer modules of the respective instances of the application on the computing devices implement the cross device visitor correlation based on the visitor identifier 124 from the mobile phone. The cloud data storage is not aware of the visitor identifier correlation for stitching the user across the multiple devices. Further, the application 106 on the mobile phone 102 and the other instance of the application 110 on the computing device 104 are agnostic to the other computing devices, and the respective data transfer modules are implemented to communicate the application data to the cloud data storage and request the application data from the cloud data storage.

The visitor profile server 112 may also be implemented with a marketing service 132 that utilizes the visitor identifiers 126, the tracking data 128, and any other user information and/or data in analytics and marketing scenarios, such as for directed advertising to particular users. Embodiments of cross device visitor correlation can be leveraged by the visitor profile server 112 for any type of marketing or other activities, such as analytics, targeting, advertising, personalization, optimization, and the like. For example, marketers and advertisers can determine user behavior across two or more computing devices based on the tracking data 128 and activity generated by a user who uses the two or more devices, where the user is identified as the same visitor.

Although the application data 108 is shown and described as being communicated from the mobile phone 102 to the computing device 104 via the cloud data storage 114 (e.g., as the stored application data 122), the application data 108 generated by the application 106 may be communicated directly from the mobile phone 102 to the computing device 104. Data transfer of the application data 108 from the mobile phone 102 to the computing device 104 can be over any type of data and/or direct connection, such as via a USB connection or via wireless connections (e.g., Wi-Fi, Bluetooth™, NFC, etc.). A memory card or device may also be used to transfer data between the computing devices.

Embodiments of cross device visitor correlation can leverage any type of current data sharing scenarios and/or communication channels to exchange visitor identifiers for analytics and visitor stitching. Subsequent tracking calls to the visitor profile server 112 from any of the computing devices can include the same visitor identifier, which is used to stitch the visitors (e.g., the user and/or the devices) together. Generally, the data that is passed from one computing device to another can include information that may be utilized to stitch the visitor identifiers together, and correlate the visitor identifiers with the user and/or with the multiple computing devices of the user.

The information can also be used to stitch visitor identifiers that are associated with a user when two computing devices are used together, such as when using a mobile phone or tablet device as a companion device when watching television programming on a television device. The portable device and the television device are already connected for data transfer and communication, and visitor identifiers can be used to associate the two devices and/or correlate the two devices with the same user. When a companion application, such as on a tablet device, connects to another device, such as the television, the companion application also communicates a visitor identifier. Subsequent tracking communications from either the television device or the companion application on the tablet device that are communicated to the visitor profile server 112 with the same visitor identifier can be determined as having been initiated by the same visitor.

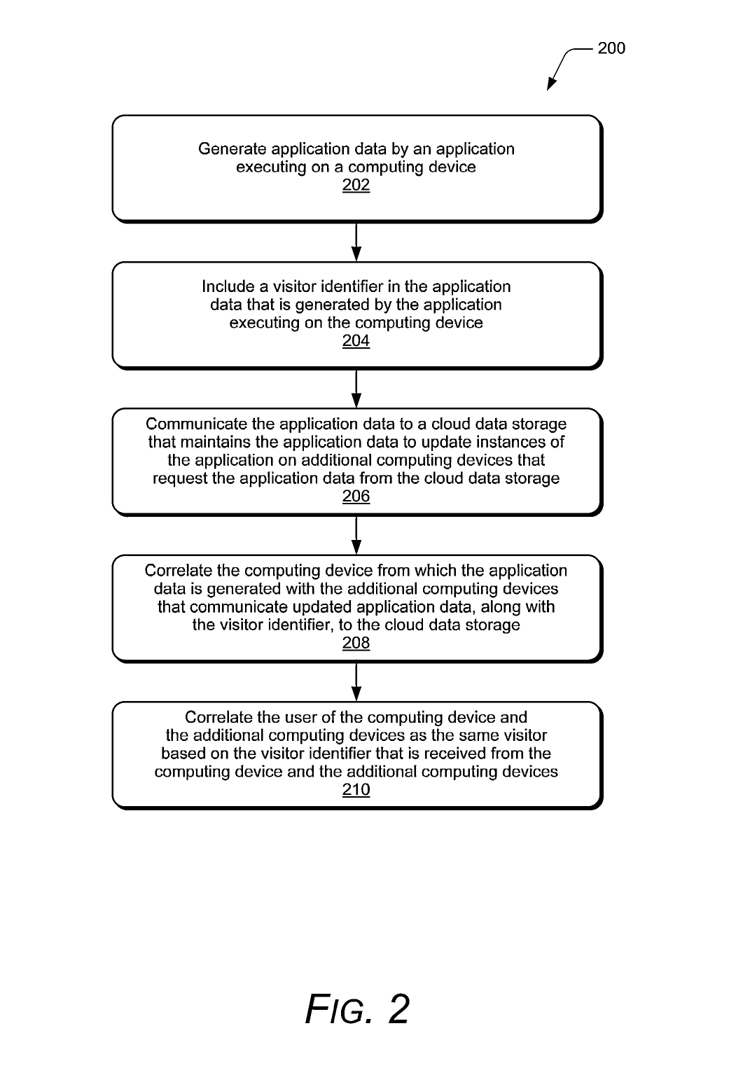

Example methods 200, 300, and 500 are described with reference to respective FIGS. 2, 3, and 5 in accordance with one or more embodiments of cross device visitor correlation. Generally, any of the services, components, modules, methods, and operations described herein can be implemented using software, firmware, hardware (e.g., fixed logic circuitry), manual processing, or any combination thereof. The example methods may be described in the general context of executable instructions stored on computer-readable storage media that is local and/or remote to a computer processing system, and implementations can include software applications, programs, functions, and the like.

FIG. 2 illustrates example method(s) 200 of cross device visitor correlation, and is generally described with reference to the example system shown in FIG. 1. The order in which the method is described is not intended to be construed as a limitation, and any number or combination of the method operations can be combined in any order to implement a method, or an alternate method.

At 202, application data is generated by an application executing on a computing device. For example, the application 106 executes on the mobile phone 102 (FIG. 1) and generates the application data 108. As described above, the application 106 may be a gaming application that the user plays on the device and the application data 108 that is generated can include any type of game status, such as points accumulated, levels attained, player updates, and any other data related to playing the gaming application. Alternatively, the application 106 may be any other type of application, such as a blog reader or a social media application that is used to view and/or contribute to selected blogs or social media posts, and the application data 108 that is generated may relate to where the user leaves off when using the application.

At 204, a visitor identifier is included in the application data that is generated by the application executing on the computing device. For example, the data transfer module 118 of the application 106 at the mobile phone 102 includes the visitor identifier 124 in the application data 108, and the visitor identifier is associated with the mobile phone for a user who is not identified at the mobile phone, such as identified from a user-provided log-in credential or from an email address. The visitor identifier 124 can identify a unique aspect of the user who is otherwise an unidentified user of the mobile phone 102 and the computing device 104. Alternatively or in addition, the visitor identifier 124 is a user identifier that is associated with the cloud data storage 114 allocated to the user of the mobile phone and the computing device.

At 206, the application data is communicated to a cloud data storage that maintains the application data to update instances of the application on additional computing devices that request the application data from the cloud data storage. For example, the data transfer module 118 of the application 106 at the mobile phone 102 initiates communication of the application data 108, along with the visitor identifier 124, to the cloud data storage 114 where the application data is maintained as the application data 122. Additionally, the visitor identifier 124 is communicated to the visitor profile server 112 as a tracking call, and the visitor profile server stores the visitor identifier as one of the visitor identifiers 126, along with any other type of tracking data 128. The computing device 104 then requests the application data 122 from the cloud data storage 114 to update the instance of the application 110 on the computing device.

At 208, the computing device from which the application data is generated is correlated with the additional computing devices that communicate updated application data, along with the visitor identifier, to the cloud data storage. For example, the visitor profile server 112 correlates the mobile phone 102 with the computing device 104 based on the visitor identifier 124 that is received along with the application data 108 from the mobile phone 102, and also received back along with updated application data from the computing device 104. Alternatively or in addition, the data transfer module 118 of the application 106 correlates the mobile phone 102 with the computing device 104 based on the visitor identifier 124. Similarly, the data transfer module 120 of the application 110 correlates the computing device 104 with the mobile phone 102 based on the visitor identifier 124.

At 210, the user of the computing device and the additional computing devices is correlated as the same visitor based on the visitor identifier. For example, the visitor profile server 112 correlates the user of the mobile phone 102 and the computing device 104 as the same visitor based on the visitor identifier 124 that is included in the application data 108 received from the mobile phone and included in updated application data received from the computing device.

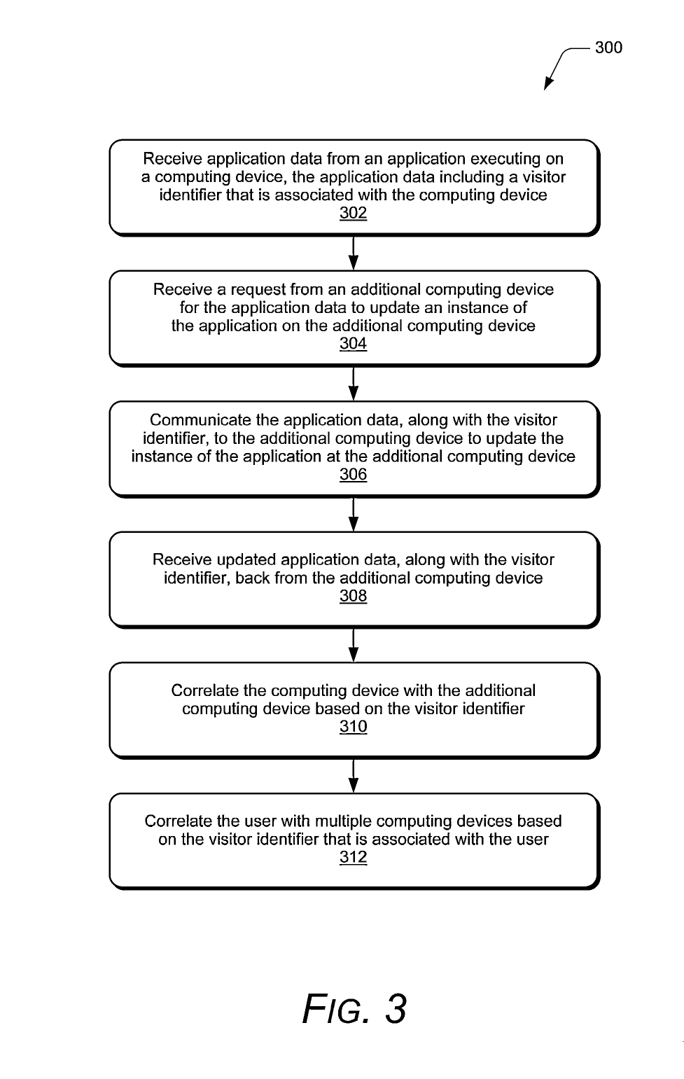

FIG. 3 illustrates example method(s) 300 of cross device visitor correlation, and is generally described with reference to the example system shown in FIG. 1. The order in which the method is described is not intended to be construed as a limitation, and any number or combination of the method operations can be combined in any order to implement a method, or an alternate method.

At 302, application data is received from a computing device for an application that is executing on the computing device, and the application data includes a visitor identifier that is associated with the computing device. For example, the cloud data storage 114 (FIG. 1) receives the application data 108 from the mobile phone 102, and the application data includes the visitor identifier 124 that is associated with the mobile phone for a user who is not identified at the mobile phone from a user-provided log-in credential or from an email address. The visitor profile server 112 receives the visitor identifier 124 that can identify a unique aspect of the user who is otherwise an unidentified user of the mobile phone 102 and of the computing device 104. Alternatively or in addition, the visitor identifier 124 is a user identifier that is associated with the cloud data storage 114 allocated to the user of the mobile phone and the computing device. The cloud data storage receives the application data 108 from the mobile phone 102 and stores the data as application data 122, along with the visitor identifier 124.

At 304, a request is received from an additional computing device for the application data to update an instance of the application on the additional computing device. For example, the cloud data storage 114 receives the data request 130 from the computing device 104 for the application data 122 that is stored when received as the application data 108 from the mobile phone 102. At 306, the application data is communicated, along with the visitor identifier, to the additional computing device to update the instance of the application that is executing on the additional computing device. For example, the cloud data storage 114 communicates the application data 122, along with the visitor identifier 124, to the computing device 104 to update the instance of the application 110 that is executing on the computing device.

At 308, updated application data, along with the visitor identifier, is received back from the additional computing device. For example, the cloud data storage 114 receives updated application data from the computing device 104, and the visitor profile server 112 receives the visitor identifier 124 back from the computing device 104. At 310, the computing device is correlated with the additional computing device based on the visitor identifier. For example, the visitor profile server 112 correlates the mobile phone 102 with the computing device 104 based on the visitor identifier 124 that is received with the application data 108 from the mobile phone, and also received back with updated application data from the computing device.

At 312, the user is correlated with multiple computing devices based on the visitor identifier that is associated with the user. For example, the visitor profile server 112 correlates the user of the mobile phone 102 and the computing device 104 as the same visitor based on the visitor identifier 124 that is included in the application data 108 received from the mobile phone 102 and included in updated application data received from the computing device 104.

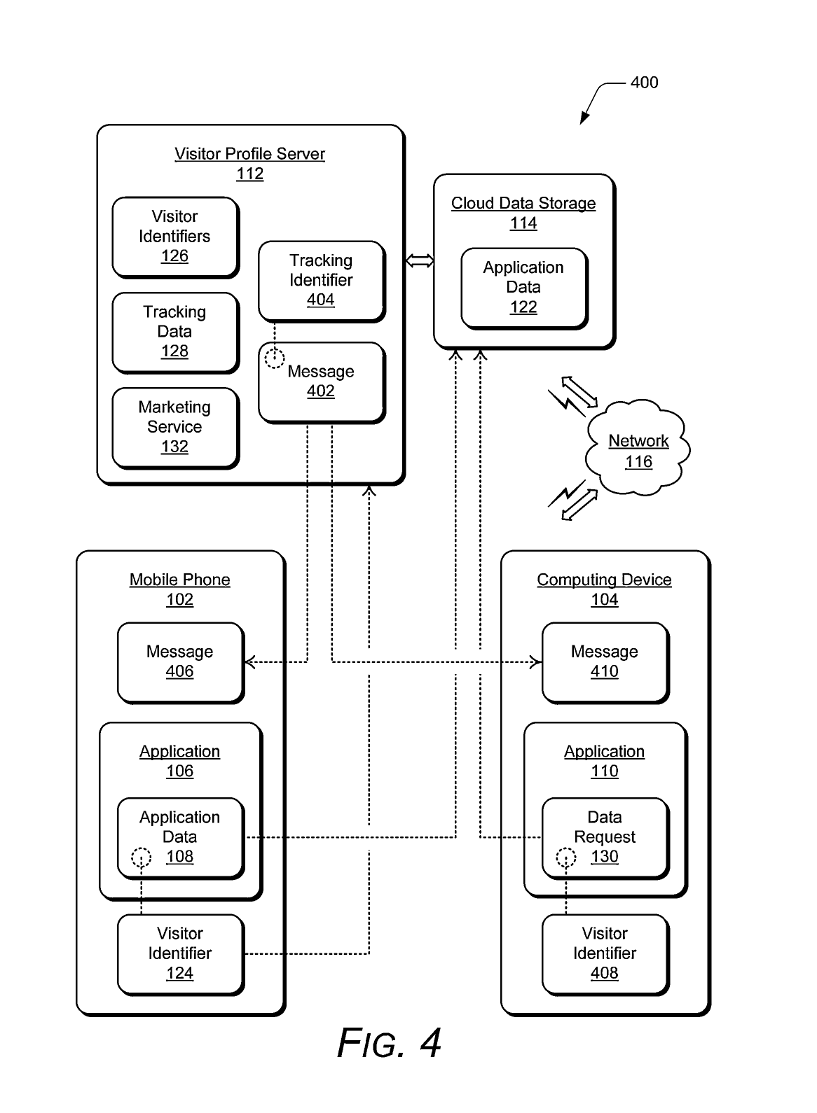

FIG. 4 illustrates another example system 400 in which embodiments of cross device visitor correlation can be implemented. The example system 400 includes the mobile phone 102, the computing device 104, the cloud data storage 114, and the network 116 as described with reference to FIG. 1. The example system 400 also includes the visitor profile server 112 that communicates via the network with the computing devices. The visitor profile server may be implemented by an advertiser, a developer, or a content provider associated with the application 106 (and the second instance of the application 110) that is installed and executable on the computing devices. The visitor profile server 112 may also include analytics tools and services that implement embodiments of cross device visitor correlation, such as to associate the computing devices and/or correlate the user with the computing devices based on the visitor identifiers. The analytics tools and services may also communicate determined analytics data to developers, content providers, advertisers, and any other type of third-party entity that can utilize analytics data.

In this example, the visitor profile server 112 can communicate a message 402, such as an email message, text message, image message, or any other type of message sent to an identified user of one or more computing devices. A message can include a tracking identifier 404 that is uniquely associated with the user of the computing devices (i.e., the mobile phone 102 and the computing device 104). Email messages in particular are frequently accessed by a user on different devices, yet the content of an email message remains the same on any device that displays the email message for viewing, and the content can be unique to a particular user. The tracking identifier 404 included in the message 402 can be implemented as a tracking code that is initiated from a selectable link in the message, and that is unique to the user, such as an offer identifier, a visitor identifier, or other type of tracking code that can be used to correlate a user with more than one computing device.

For example, a user may receive an email message with a selectable link for a tracking code ‘abc’ and click on the link from the mobile phone 102, which opens an Internet page or Web site that identifies the user as visitor ‘123’, such as in a browser cookie. The tracking code ‘abc’ can then be associated with the visitor identifier ‘123’. The user may then view the email message on the computing device 104 and again click to open the link, which opens the Internet page or Web site that identifies the user as visitor identifier ‘456’. The tracking code ‘abc’ can then also be associated with the visitor identifier ‘456’, and the cloud-based service can determine that visitor ‘123’ is the same as visitor ‘456’, which are both associated with the user as identified by the message address or routing.

Alternatively or in addition, the tracking identifier 404 included in the message 402 can be implemented as a tracking pixel that includes a unique identifier or tracking code. Most email client applications support viewing images in emails, and will display a tracking pixel with the images. Although a client device may initially block images from being downloaded and displayed for viewing, all of the images including the tracking pixel will be displayed if the user enables images for the message, such as to see the message header or a coupon displayed in the message. Additionally, for Web-based email clients that allow use of browser application cookies, the visitor identifiers can be stored and associated with the tracking pixel.

In non-Web based environments, tracking pixels can be implemented for email clients that embed viewers to display HTML format emails for viewing, where cookies and/or user-agents may be implemented. In this instance, the message header information with the IP address and user agent can be combined and hashed to form a unique identifier. If later, from the same computing device, the user opens a Web site or an application with tracking enabled, such as by a visitor identifier stored in a browser cookie, and the header information matches a previous email client request, both the hashed header information and the associated tracking code can be correlated as aliases of the visitor identifier to stitch together an identity of the user.

The message 402 can also include an incentive related to the application 106 that is executable on the mobile phone 102, and related to the second instance of the application 110 that is executable on the computing device 104. The incentive is provided so that the user will open a tracking link while viewing the message on both the mobile phone 102 and on the computing device 104, as well as on other computing devices that are associated with the user. In the gaming application example, the user may open the received message 406 on the mobile phone 102 and initiate an incentive or enter a promotion code that is associated with the gaming application, such as to unlock levels of the game, receive rewards, advance players, and/or other benefits if the user also opens the received message on the computing device 104.

The visitor profile server 112 can then receive the visitor identifier 124 from the mobile phone 102 along with the tracking identifier 404 when the incentive is initiated by the user at the mobile phone. The visitor profile server also receives a visitor identifier 408 from the computing device 104 along with the tracking identifier 404 when the incentive that is included in the received message 410 is initiated by the user at the computing device. The visitor identifier 124 received from the mobile phone 102 and the visitor identifier 408 received from the computing device 104 are correlated and maintained at the visitor profile server as the visitor identifiers 126.

In this example, the visitor identifier 124 received from the mobile phone 102 may be different than the visitor identifier 408 received from the computing device 104. However, the visitor profile server 112 can correlate the visitor identifier 124 from the mobile phone and the visitor identifier 408 from the computing device with the user of both devices based on the tracking identifier 404 being received back from both of the devices. Additionally, the user can be correlated with the mobile phone 102 and with the computing device 104 based on the tracking identifier being received back from both of the devices.

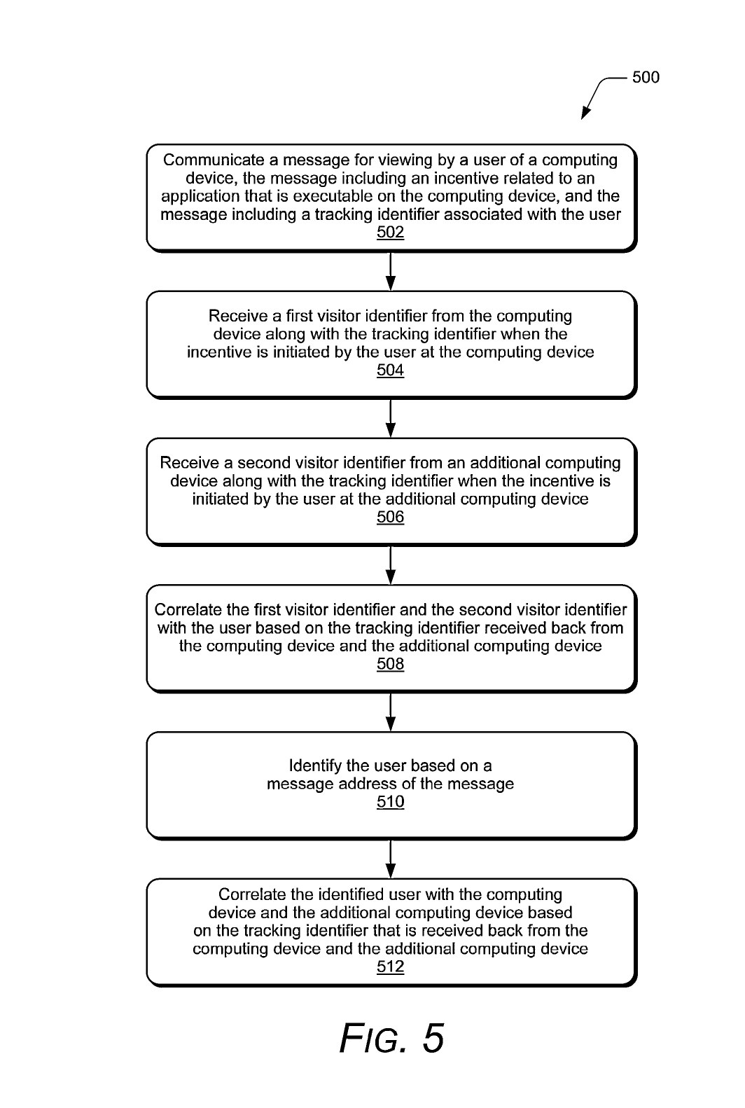

FIG. 5 illustrates example method(s) 500 of cross device visitor correlation, and is generally described with reference to the example system shown in FIG. 4. The order in which the method is described is not intended to be construed as a limitation, and any number or combination of the method operations can be combined in any order to implement a method, or an alternate method.

At 502, a message is communicated for viewing by a user of a computing device, where the message includes an incentive related to an application that is executable on the computing device, and the message includes a tracking identifier associated with the user. For example, the visitor profile server 112 (FIG. 4) communicates the message 402, such as an email message, text message, image message, or any other type of message sent to a user of one or more computing devices. The message 402 includes the tracking identifier 404, which may be a tracking code or tracking pixel. The message 402 can also include an incentive related to the application 106 that is executable on the mobile phone 102 and related to the instance of the application 110 that is executable on the computing device 104. The incentive is provided so that the user will open a tracking link while viewing the message on both the mobile phone 102 and on the computing device 104, as well as on other computing devices that are associated with the user.

At 504, a first visitor identifier is received from the computing device along with the tracking identifier when the incentive is initiated by the user at the computing device. For example, the visitor profile server 112 receives the tracking identifier 404 back from the mobile phone 102 along with the visitor identifier 124 that identifies the mobile phone when the user initiates the incentive that is included in the received message 406.

At 506, a second visitor identifier is received from an additional computing device along with the tracking identifier when the incentive is initiated by the user at the additional computing device. For example, the visitor profile server 112 receives the tracking identifier 404 from the computing device 104 along with the visitor identifier 408 that identifies the computing device 104 when the user initiates the incentive that is included in the received message 410.

At 508, the first visitor identifier and the second visitor identifier are correlated with the user based on the tracking identifier received back from the computing device and the additional computing device. For example, the visitor profile server 112 correlates the first visitor identifier 124 and the second visitor identifier 408 with the user based on the tracking identifier 404 that is received back from both the mobile phone 102 and the computing device 104.

At 510, the user is identified based on a message address of the message and, at 512, the identified user is correlated with the computing device and the additional computing device based on the tracking identifier that is received back from the computing device and the additional computing device. For example, the user of the mobile phone and the computing device is identifiable from a message address of the message 402, and the visitor profile server 112 correlates the identified user with the mobile phone 102 and with the computing device 104 based on the tracking identifier 404 that is received back from both the mobile phone and the computing device.

FIG. 6 illustrates an example system 600 that includes an example device 602, which can implement embodiments of cross device visitor correlation. The example device 602 can be implemented as any of the computing devices and/or services (e.g., server devices) described with reference to the previous FIGS. 1-5, such as any type of client device, mobile phone, tablet, computing, communication, entertainment, gaming, media playback, and/or other type of device. For example, the mobile phone 102, the computing device 104, the visitor profile server 112, and/or the cloud data storage 114 shown in FIGS. 1 and 4 may be implemented as the example device 602.

The device 602 includes communication devices 604 that enable wired and/or wireless communication of device data 606, such as application data that is transferred from one computing device to another, and/or synched between multiple computing devices. The device data can include any type of audio, video, and/or image data, such as application data that is generated by applications executing on the device. The communication devices 604 can also include transceivers for cellular phone communication and/or for network data communication.

The device 602 also includes input/output (I/O) interfaces 608, such as data network interfaces that provide connection and/or communication links between the device, data networks, and other devices. The I/O interfaces can be used to couple the device to any type of components, peripherals, and/or accessory devices, such as a digital camera device that may be integrated with device 602. The I/O interfaces also include data input ports via which any type of data, media content, and/or inputs can be received, such as user inputs to the device, as well as any type of audio, video, and/or image data received from any content and/or data source.

The device 602 includes a processing system 610 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 602 may further include any type of a system bus or other data and command transfer system that couples the various components within the device. A system bus can include any one or combination of different bus structures and architectures, as well as control and data lines.

The device 602 also includes computer-readable storage media 612, such as data storage devices that can be accessed by a computing device, and that provide persistent storage of data and executable instructions (e.g., software applications, programs, functions, and the like). Examples of computer-readable storage media include volatile memory and non-volatile memory, fixed and removable media devices, and any suitable memory device or electronic data storage that maintains data for computing device access. The computer-readable storage media can include various implementations of random access memory (RAM), read-only memory (ROM), flash memory, and other types of storage media in various memory device configurations.

The computer-readable storage media 612 provides storage of the device data 606 and various device applications 614, such as an operating system that is maintained as a software application with the computer-readable storage media and executed by the processing system 610. In this example, the device applications also include a data transfer module 616 that implements embodiments of cross device visitor correlation, such as when the example device 602 is implemented as the mobile phone 102 and/or the computing device 104 shown in FIGS. 1 and 4. Examples of the data transfer module 616 include the data transfer module 118 of the application 106 on the mobile phone 102, and the data transfer module 120 of the application 110 on the computing device 104, as described with reference to FIGS. 1-5.

The device 602 also includes an audio and/or video system 618 that generates audio data for an audio device 620 and/or generates display data for a display device 622. The audio device and/or the display device include any devices that process, display, and/or otherwise render audio, video, display, and/or image data, such as the image content of a digital photo. In implementations, the audio device and/or the display device are integrated components of the example device 602. Alternatively, the audio device and/or the display device are external, peripheral components to the example device.

In embodiments, at least part of the techniques described for cross device visitor correlation may be implemented in a distributed system, such as over a “cloud” 624 in a platform 626. The cloud 624 includes and/or is representative of the platform 626 for services 628 and/or resources 630. For example, the services 628 may include the visitor profile server 112 and/or the cloud data storage 114 described with reference to FIGS. 1 and 4. Additionally, the resources 630 may include a data transfer module implemented by a computing device that correlates visitor identifiers with the computing devices and/or with a user of the multiple computing devices.

The platform 626 abstracts underlying functionality of hardware, such as server devices (e.g., included in the services 628) and/or software resources (e.g., included as the resources 630), and connects the example device 602 with other devices, servers, etc. The resources 630 may also include applications and/or data that can be utilized while computer processing is executed on servers that are remote from the example device 602. Additionally, the services 628 and/or the resources 630 may facilitate subscriber network services, such as over the Internet, a cellular network, or Wi-Fi network. The platform 626 may also serve to abstract and scale resources to service a demand for the resources 630 that are implemented via the platform, such as in an interconnected device embodiment with functionality distributed throughout the system 600. For example, the functionality may be implemented in part at the example device 602 as well as via the platform 626 that abstracts the functionality of the cloud 624.

Although embodiments of cross device visitor correlation have been described in language specific to features and/or methods, the appended claims are not necessarily limited to the specific features or methods described. Rather, the specific features and methods are disclosed as example implementations of cross device visitor correlation.

1. A method, comprising:
generating application data by an application executing on a computing device;
including a visitor identifier in the application data by a data transfer module of the application, the visitor identifier associated with the computing device for a user who is not identified at the computing device from a user-provided log-in credential; and
communicating the application data with the visitor identifier to a cloud data storage that maintains the application data to update instances of the application on one or more additional computing devices that request the application data from the cloud data storage.

2. A method as recited in claim 1, wherein an additional computing device receives the application data along with the visitor identifier from the cloud data storage to update an instance of the application on the additional computing device, the visitor identifier returned to the cloud data storage with updated application data from the additional computing device.

3. A method as recited in claim 2, wherein the computing device from which the application data is generated is correlated with the additional computing device that requests the application data based on the visitor identifier.

4. A method as recited in claim 2, wherein the user of the computing device and the additional computing device is correlated as a same visitor based on the visitor identifier that is included in the application data received from the computing device and included in the updated application data received from the additional computing device.

5. A method as recited in claim 1, wherein the visitor identifier identifies a unique aspect of the user who is otherwise an unidentified user of the computing device and the one or more additional computing devices.

6. A method as recited in claim 1, wherein the user is correlated with multiple computing devices based on the visitor identifier that is associated with the user who is not identified from the log-in credential or an email address at the multiple computing devices.

7. A method as recited in claim 1, further comprising receiving a message that is communicated to the computing device for viewing by the user, the message having relevance to the application executing on the computing device; wherein:
the visitor identifier is a tracking code received in the message; and
a request for the application data from an additional computing device includes the tracking code that is also received in the message at the additional computing device.

8. A method as recited in claim 1, further comprising receiving a message that is communicated to the computing device; wherein:
the visitor identifier is a tracking pixel included in the message; and
a request for the application data from an additional computing device includes the tracking pixel that is also included in the message received at the additional computing device.

9. A method, comprising:
receiving application data from a computing device for an application that is executing on the computing device, the application data including a visitor identifier that is associated with the computing device for a user who is not identified at the computing device from a user-provided log-in credential;
receiving a request from an additional computing device for the application data to update an instance of the application on the additional computing device;
communicating the application data along with the visitor identifier that is associated with the computing device to the additional computing device to update the instance of the application at the additional computing device;
receiving updated application data from the additional computing device, the updated application data including the visitor identifier; and
correlating the computing device with the additional computing device based on the visitor identifier.

10. A method as recited in claim 9, further comprising correlating the user of the computing device and the additional computing device as a same visitor based on the visitor identifier that is included in the application data received from the computing device and included in the updated application data received from the additional computing device.

11. A method as recited in claim 9, wherein the visitor identifier identifies a unique aspect of the user who is otherwise an unidentified user of the computing device and the additional computing device.

12. A method as recited in claim 9, further comprising correlating the user with multiple computing devices based on the visitor identifier that is associated with the user who is not identified from the log-in credential or an email address at the multiple computing devices.

13. A method as recited in claim 9, wherein:
the visitor identifier is a user identifier that is associated with cloud data storage allocated to the user of the computing devices; and
the method further comprising correlating the computing device and the additional computing device with the user based on the user identifier.

14. A method as recited in claim 9, wherein:
the visitor identifier is a tracking code included in a message that is received at the computing device for viewing by the user, the message having relevance to the application executing on the computing device;
said receiving the application data that includes the tracking code from the computing device; and
said receiving the updated application data from the additional computing device includes the tracking code that is also received in the message at the additional computing device.

15. A method as recited in claim 14, further comprising:
identifying the user based on a message address of the message; and
correlating the computing device and the additional computing device with the identified user based on the tracking code.

16. A method as recited in claim 9, wherein:
the visitor identifier is a tracking pixel included in a message that is received at the computing device;
said receiving the application data that includes the tracking pixel from the computing device;
said receiving the updated application data from the additional computing device includes the tracking pixel that is also received in the message at the additional computing device; and
the method further comprising correlating the computing device and the additional computing device with the identified user based on the tracking pixel.

17. A method, comprising:
communicating a message for viewing by a user of a computing device, the message including an incentive related to an application that is executable on the computing device, and the message including a tracking identifier associated with the user;
receiving a first visitor identifier from the computing device along with the tracking identifier when the incentive is initiated by the user at the computing device;
receiving a second visitor identifier from an additional computing device along with the tracking identifier when the incentive is initiated by the user at the additional computing device; and
correlating the first visitor identifier and the second visitor identifier with the user based on the tracking identifier received back from the computing device and the additional computing device.

18. A method as recited in claim 17, wherein:
the first visitor identifier identifies the computing device;
the second visitor identifier identifies the additional computing device; and
the method further comprising correlating the user with the computing device and the additional computing device based on the tracking identifier received back from the computing device and the additional computing device.

19. A method as recited in claim 17, wherein the tracking identifier is one of:
a tracking code included in the message; or
a tracking pixel included in the message.

20. A method as recited in claim 17, further comprising:
identifying the user based on a message address of the message; and
correlating the computing device and the additional computing device with the identified user based on the tracking identifier received back from the computing device and the additional computing device.

21. Computer-readable storage media comprising one or more applications stored as instructions that are executable and, responsive to execution of the instructions by a computing device, the computing device performs operations comprising to:
receive application data from a computing device for an application that is executing on the computing device, the application data including a visitor identifier that is associated with the computing device for a user who is not identified at the computing device;
receiving a request from an additional computing device for the application data to update an instance of the application on the additional computing device;
communicating the application data along with the visitor identifier that is associated with the computing device to the additional computing device to update the instance of the application at the additional computing device;
receiving updated application data from the additional computing device, the updated application data including the visitor identifier; and
correlating the computing device with the additional computing device based on the visitor identifier.

22. Computer-readable storage media as recited in claim 21, wherein the computing device performs the operations further comprising to:
correlate the user with multiple computing devices based on the visitor identifier that is associated with the user who is not identified from a log-in credential or an email address at the multiple computing devices.

23. Computer-readable storage media as recited in claim 21, wherein:
the visitor identifier is a user identifier that is associated with cloud data storage allocated to the user of the computing devices; and
the computing device performs the operations further comprising to correlate the computing device and the additional computing device with the user based on the user identifier.

24. Computer-readable storage media comprising one or more applications stored as instructions that are executable and, responsive to execution of the instructions by a computing device, the computing device performs operations comprising to:
communicate a message for viewing by a user of a computing device, the message including an incentive related to an application that is executable on the computing device, and the message including a tracking identifier associated with the user;
receive a first visitor identifier from the computing device along with the tracking identifier when the incentive is initiated by the user at the computing device;
receive a second visitor identifier from an additional computing device along with the tracking identifier when the incentive is initiated by the user at the additional computing device; and
correlate the first visitor identifier and the second visitor identifier with the user based on the tracking identifier received back from the computing device and the additional computing device.

25. Computer-readable storage media as recited in claim 24, wherein:
the first visitor identifier identifies the computing device;
the second visitor identifier identifies the additional computing device; and
the computing device performs the operations further comprising to correlate the user with the computing device and the additional computing device based on the tracking identifier received back from the computing device and the additional computing device.
